(19) United States
(12) Patent Application Publication
(10) Pub. No.: US 2017/0246602 A1
(43) Pub. Date: Aug. 31, 2017

(54) PERSONAL FORMULATION DEVICE

(71) Applicant: Access Business Group International LLC, Ada, MI (US)

(72) Inventors: Cody D. Dean, Grand Rapids, MI (US); Ryan D. Schamper, Grand Haven, MI (US); Joseph C. Van Den Brink, Coopersville, MI (US); David W. Baarman, Fennville, MI (US); Richard J. Weber, Grand Haven, MI (US); Michele Luciano Lazzari, Cape Town (ZA); Derek Hedley Rowles, Cape Town (ZA); Clinton Les Foster, Cape Town (ZA)

(21) Appl. No.: 15/517,221

(22) PCT Filed: Oct. 1, 2015
(86) PCT No.: PCT/US2015/053391

§ 371 Date: Apr. 6, 2017

Related U.S. Application Data
(60) Provisional application No. 62/060,661, filed on Oct. 7, 2014.

(51) Int. Cl. B01F 13/10; B01F 13/00; B01F 5/06; A45D 44/00; B01F 3/08; F04C 2/107; F04C 11/00; F04C 15/00; B01F 15/02; B01F 15/00

(52) U.S. Cl. CPC B01F 13/1063; B01F 15/0243; B01F 13/0033; B01F 5/0606; B01F 15/00922; B01F 15/00305; B01F 3/0861; F04C 2/1073; F04C 11/001; F04C 15/0034; A45D 44/00; B01F 2215/005; B01F 2215/0031

(57) ABSTRACT

A personal formulation device for mixing and dispensing customized formulations from ingredient reservoirs carried by the device. The device may include a plurality of miniaturized progressive pumps with a flexible coupling between the motor and the pump. The coupling may include a spring (40). The device may include a spacer sleeve (62) having an internal diameter tapered to closely follow the motion envelope of the spring (40). Each pump may include a retainer (60) that is threaded into the interior of the pump body (52) to retain the spacer sleeve (62) and the drive end (120) of the rotor (34). Each pump may include a stator with an integrated flange seal (36). The flange seal (36) may extend around the circumference of the stator and be sandwiched between portions of the pump body (52). The stator may have a noncircular shape that keys the stator within the pump body. The pump may include an optical metering system.

### BACKGROUND OF THE INVENTION

The present invention relates to formulation devices and more particularly to a portable formulation device capable of mixing and dispensing customized formulations from a variety of different ingredients.

There are a variety of devices in the market capable of producing custom-mixed formulations from various individual ingredients. For example, some hardware and home improvement stores have custom paint blending systems that are capable of producing customized paint products. As another example, some stores that offer cosmetics have systems capable of producing custom-blended cosmetics for customers. In some cases, the system includes an automated system for arriving at the appropriate cosmetic formulation. Automated systems of this nature for cosmetic formulations generally include an imaging system for capturing an image of a customer and a computer programmed to analyze the image and select an appropriate cosmetic formulation based on information extracted from image, such as skin color and tone. Although these types of custom formulation systems can be a feasible option in a commercial setting, they are large and expensive and therefore not well-suited for personal or home use.

There is a growing interest for a personal device that is capable of producing custom formulations from a variety of different ingredients. In fact, a number of portable devices capable of providing this functionality are known. For example, a miniaturized fluid composition dispenser capable of combining a variety of constituent fluids is shown in U.S. Pat. No. 8,224,481 to Bylsma et al. Another example is shown in U.S. Pat. No. 5,709,317 to Bertram et al. Although a number of portable mixing and dispensing systems exist, it is believed that there would be significant interest in an improved miniaturized device that is capable of mixing and dispensing a variety of customized formulations.

### SUMMARY OF THE INVENTION

The present invention provides a personal formulation device that is capable of effective mixing and dispensing customized formulations from a plurality of ingredient reservoirs carried by the device. The personal formulation device includes a plurality of miniaturized pumps that are capable of accurately metering and dispensing a plurality of ingredients in accordance with customized formulations. In one embodiment, the personal formulation device includes a plurality of progressive pumps. The progressive pumps are specially configured to function properly in a miniaturized environment. With these progressive pumps, the ingredients from the different reservoirs may be accurately metered and dispensed into a common receptacle where the can be mixed manually.

In one embodiment, each of the progressive pumps includes a coupling between the motor and the pump. The coupling may include a spring that functions as a drive shaft to couple the motor output to the rotor. The spring allows for eccentric movement of the rotor while also providing a bias that urges the shoulder of the rotor into the running surface of the retainer. The coupling may also include a spacer sleeve that performs a variety of functions. For example, the spacer sleeve is configured to reduce the volume of open space within the pump body. The spacer sleeve includes an internal diameter that is tapered to closely follow the motion envelope of the spring.

In one embodiment, the progressive pump includes a retainer that is threaded into the interior of the pump body to retain the spacer sleeve and the drive end of the rotor. The retainer may include an internal circular through-bore through which the rotor passes. The internal bore may correspond in diameter with the motion envelope of the rotor. The rotor may include an enlarged shoulder. In such embodiments, the internal bore may include a counter-bore configured to receive the shoulder. The counter-bore may include a running surface that is engaged with a shoulder of the rotor. The counter-bore may correspond in diameter with the motion envelope of the shoulder. The shoulder may be sandwiched between the end of the spacer sleeve and the running surface of the retainer to help retain the rotor in the proper position with respect to the stator.

In one embodiment, the pump body includes an O-ring seal that seals the interface with the motor draft shaft. The spacer sleeve may include a closed end that engages the O-ring seal to prevent axial movement of the O-ring seal along the motor drive shaft.

In one embodiment, the progressive pump may include a stator that is specially configured for use in a miniaturized application. The stator may include an integrated flange seal on its outer perimeter. The flange seal may be sandwiched between two portions of the pump body to form an effective seal and to accurately position the stator the proper axial location. The flange seal is configured so that compression of the seal does not alter the geometry of the stator. The outlet end of the stator may be oval in cross section to key the stator within the pump body and to resist rotation of the stator within the pump body. The inlet end of the stator may be round to provide accurate location within the circular cross section of the pump, which is circular to accommodate the threaded retainer.

In one embodiment, the pump includes a metering system that measures volume based on rotational movement of the motor output shaft. In one embodiment, the motor includes a gearbox with a reduction ratio of about 1:60. The metering system may include an optical measuring system having an encoding disk that is carried by a coupler that is joined to the gearbox output. The encoding disk may include a plurality of slots arranged in a radially symmetric pattern around the encoding disk. In one embodiment, a light source and a photosensor are arranged on opposite sides of the encoding disk so the slots in the rotating encoding disk produce light pulses that pass from the light source to the photosensor. In operation, the number of light pulse provides an accurate measurement of the rotation of the rotor and, consequently, the volume pumped. In embodiment, the encoding disk includes about 45 slots so that each pulse represents about 8 degrees of rotational movement of the rotor.

In one embodiment, the personal formulation device may include a stylus for dispensing product. The stylus may include an internal mixing chamber that receives ingredients from each of the pumps. The stylus may include a single outlet that dispenses the ingredients after they have been combined in the mixing chamber. The stylus may include a plurality of supply tubes that separately deliver the ingredients from the different pumps to the mixing chamber. Alternatively, the stylus may include a single supply tube to which the separate ingredients are provided. In use, mixing of the ingredients may results inherently as the ingredients travel together the length of the supply tube to a mixing chamber or directly to an outlet.

The present invention provides a simple and effective personal formulation device that is small in size yet capable of dispensing ingredients with a high degree of accuracy. The progressive pump of one embodiment includes a simple and effective flexible coupling between the motor and the rotor. When used, the coil spring flexible coupling is easily joined to the input shaft and the rotor, and it also provides a bias that helps to maintain a seal between the rotor and the retainer. The use of a stator with an integrated seal simplifies construction and assembly of the pump assemblies. It may also extend the overall life of the pump assembly. When employed, a noncircular stator and a corresponding noncircular housing help to key the stator in the correct orientation and to prevent undesirable rotation of the stator within the housing. The use of an optical metering system helps to ensure accurate dispensing volume without excessively complex or expensive mechanisms. The device may also include a stylus to facilitate dispensing and mixing of the ingredients.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is a perspective view of a personal formulation device in accordance with an embodiment of the present invention.

FIG. 2 is a partially exploded perspective view of the personal formulation device.

FIG. 3 is a partially exploded perspective view of the personal formulation device.

FIG. 4 is an exploded perspective view of a pump assembly.

FIG. 5 is a sectional view of the pump assembly.

FIG. 6A is a sectional view of the stator.

FIG. 6B is an end view of the stator.

FIG. 7 is a front view of a rotor.

FIG. 8 is a representational view of a first rotor showing the stroke volume.

FIG. 9 is a representational view of a second rotor showing the stroke volume.

FIG. 10 is a sectional view of a pump assembly.

FIG. 11 is a sectional view of a pump assembly with portions removed to highlight the various seals.

FIG. 12 is a perspective view of the personal formulation device with portions made transparent.

FIG. 13 is a perspective view of a stylus.

FIG. 14 is a perspective view of an alternative stylus.

FIG. 15 is a flow chart of a method for using the personal formulation device.

FIG. 16A is a perspective view of an encoding disk.

FIG. 16B is an exploded perspective view of an encoding disk and a coupling shaft.

FIG. 16C is a perspective view of the coupling shaft with attached encoding disk.

FIG. 17A is an exploded perspective view of a cartridge.

FIG. 17B is a sectional view of the cartridge.

FIG. 17C is an enlarged view of a portion of the cartridge.

FIG. 18A is a perspective view of another alternative stylus.

FIG. 18B is a perspective view of the alternative stylus of FIG. 18A.

FIG. 19 is a partially exploded perspective view of another alternative stylus with mixing balls.

FIG. 20 is a partially exploded perspective view of yet another alternative stylus having a replaceable tip.

FIG. 21 is a representation of a water treatment system incorporating a personal formulation device in accordance with an embodiment of the present invention.

### DESCRIPTION OF THE CURRENT EMBODIMENT

Overview.

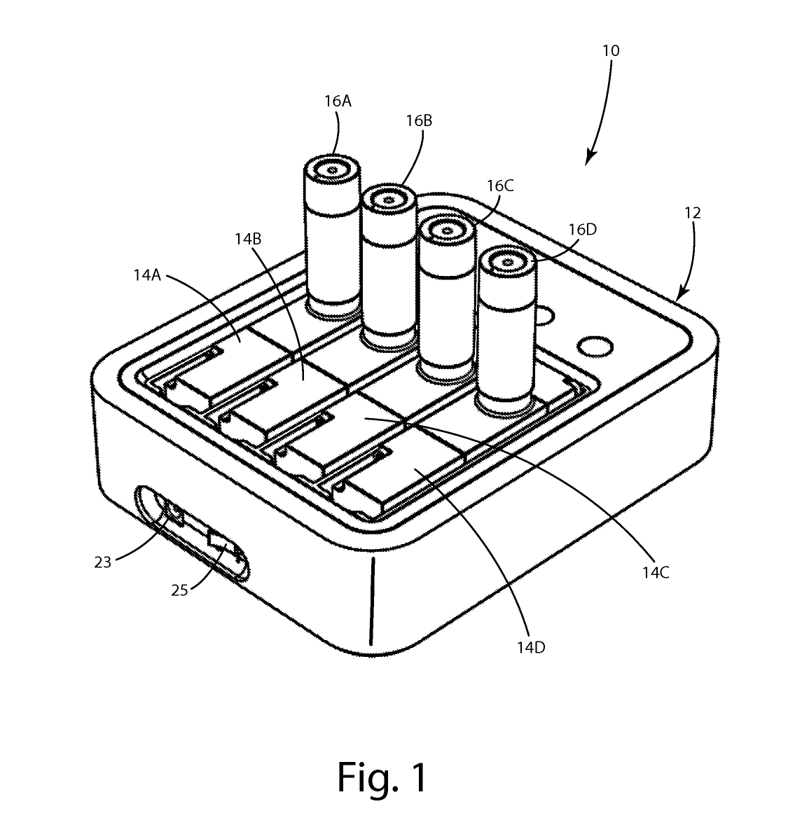

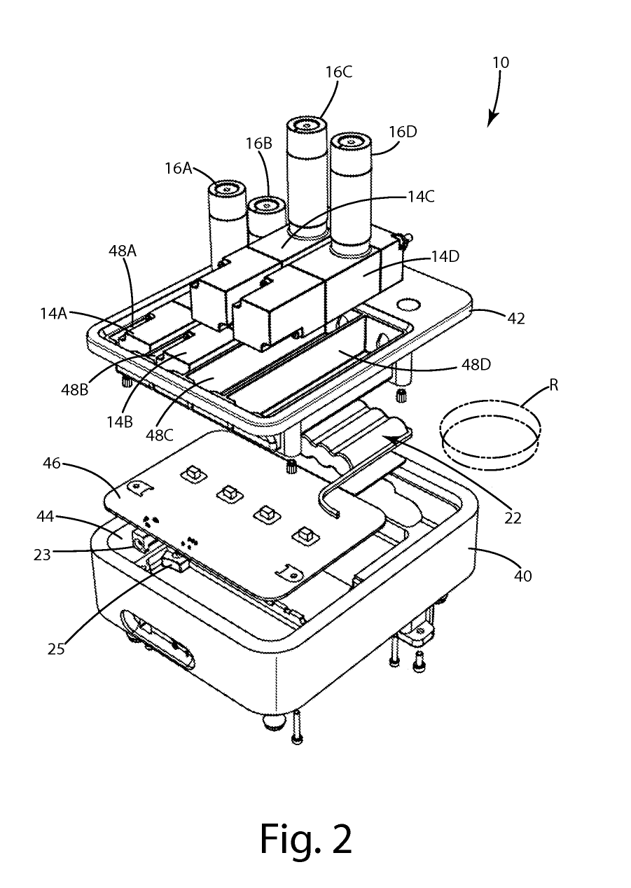

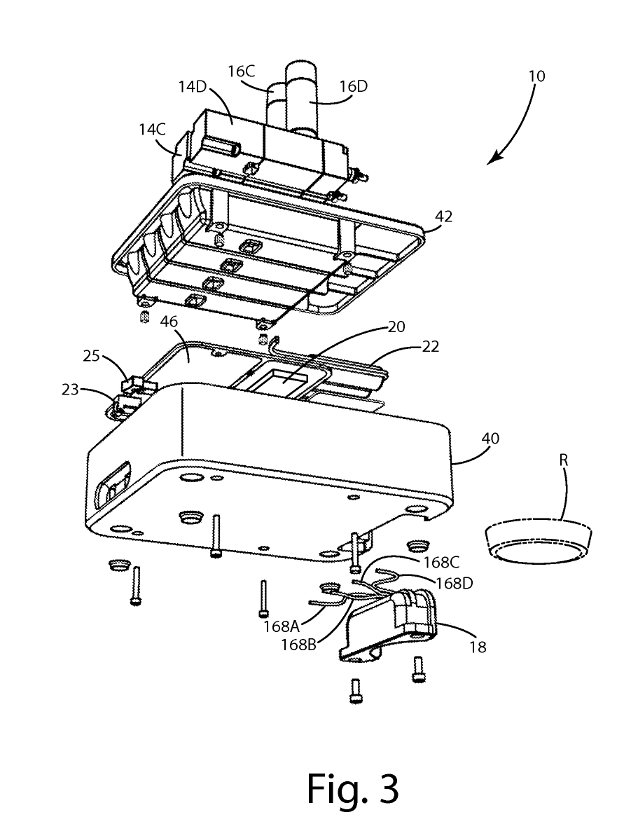

A personal formulation device 10 in accordance with an embodiment of the present invention in shown in FIG. 1. The personal formulation device 10 is capable of producing customized formulations from a plurality of ingredients. The device 10 generally includes a housing 12, a plurality of pump assemblies 14a-d, a plurality of cartridges 16a-d and a dispensing head 18. In this embodiment, there is a separate pump assembly 14a-d for each cartridge 16a-d. This allows the contents of each cartridge 16a-d to be separately metered and dispensed by a dedicated pump assembly 14a-d. In this embodiment, each of the pump assemblies 14a-d includes a progressive pump. Each progressive pump 14a-d may include a pump housing 30 that houses a stator 32 and a rotor 34. The stator 32 may include an integrated flange seal 36 that locates the stator 32 within the pump housing 30 and seals the interface between adjacent portions of the pump housing 30. The rotor 34 may include a shoulder 72 that allows the rotor 34 to be secured in the pump housing 30 by a retainer 60. The pump assembly 14a-d may include a flexible coupling for joining the rotor 34 to the motor. The coupling may include a coil spring 40 that accommodates eccentric motion of the rotor 34 and provides a bias to urge the shoulder of the rotor 34 into the interfacing surface of the retainer 60.

In this embodiment, the device 10 includes a controller 20 that is capable of operating the pump assemblies 14a-d in accordance with customized product formulations. The controller 20 may obtain the customized product formulation through user input or through communication with an external device (not shown). For example, the controller 20 may obtain the product formulation from a handheld electronic device running an application configured to communicate with the device 10 through WiFi, Bluetooth or other wireless communication system. The application may be configured to ask questions that allow the application to determine the appropriate combination of ingredients, or it may allow manual entry of the custom formulation. For example, in the illustrated embodiment, which is intended for use in dispensing cosmetic formulations, the application may ask questions regarding skin tone, skin type, skin dryness, environmental humidity, expected UV exposure, scent preferences, color preferences, shade preferences and other potentially relevant factors to determine the appropriate cosmetic formulation. As an alternative example, the device may allow the user to manually input the desired formulation, such as by specifying the ingredients and their respective amounts.

The present invention is described in the context of a personal formulation device 10 intended to produce customized cosmetic formulations. In this context, the device may dispense a wide variety of materials that may be useful in cosmetics. The present invention may, however, be used to dispense essentially any combination of ingredients that can be moved by the pump assemblies. This includes essentially any liquids and other materials that exhibit fluid flow characteristics compatible with the pump assemblies. For example, the device 10 may be configured to produce a custom combination of nutritional supplements that can be taken as a meal supplement. The ingredients may include vitamins, minerals and other supplements, as well as other ingredient intended to assist in consumption, such as flavor additives. The device may also dispense food ingredients, such as spice, oils, vinegars, extracts and other potential recipe ingredients. As another example, the device 10 may be configured to dispense custom additives for use in beverages, such as drinks, shakes and smoothies. The beverage additives may include flavor additives (e.g. sweetener, fruit flavors) or functional additives (e.g. vitamins, minerals and food supplements, and thickening ingredients, thinning ingredients and preservatives). As yet another example, the device 10 may dispense homecare formulations, such as cleaners, polishes, bleaches and concentrated liquids. In this context, the cartridges may be provided with different concentrated liquids, including cleaning agents, bleaches, hydrogen peroxide, and scent additives. The device may dispense the actual homecare formulation or it may dispense a formulation that is intended to be added to a base product, such as a base cleaning product. In the context of washing clothes, the device may dispense detergent, scent, fabric softener and other ingredients. The formulation may be customized by inputting information about the clothes to be washed into the device or into an application run on a separate device. In the context of dish washing, the device may dispense dish washing detergent, anti-spotting additives, drying agents, scent and possibly other ingredients.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

Construction.

The personal formulation device 10 generally includes a housing 12, a plurality of pump assemblies 14a-d disposed within the housing 12, a plurality of cartridges 16a-d holding ingredients (one mounted to each pump assembly 14a-d), a dispensing head 18 for dispensing the ingredients from the device 10 and a controller 20 for controlling operation of the device 10, for example, by separately controlling the pump assemblies 14a-d to dispense the appropriate amounts of each ingredient. Although the housing 12 may vary from application to application, in the illustrate embodiment, the housing 12 generally includes a base 40 and a tray insert 42. The base 40 and tray insert 42 cooperatively define an interior space 44 that, in this embodiment, houses a circuit board 46 and a battery pack 22. The tray insert 42 is fitted into the base 40 and includes a plurality of separate compartments 48a-d, each configured to receive one of the pump assemblies 14a-d.

In the illustrated embodiment, the personal formulation device 10 includes a separate pump assembly 14a-d for each cartridge 16a-d. This allows the contents of each cartridge 16a-d to be separately metered and dispensed by a dedicated pump assembly 14a-d. In the illustrated embodiment, the device 10 includes progressive pumps, but the pump type may vary in some applications. In this embodiment, the pump assemblies 14a-d are generally identical to one another, and therefore only one pump assembly will be described in detail. Although the illustrated device 10 includes a plurality of essentially identical pump assemblies, the pump assemblies may vary from one another, if desired. For example, in an alternative embodiment intended to dispense ingredients of materially different viscosities, it may be desirable to have different pump assemblies that are configured for dispensing materials of different viscosity ranges. To help assure that ingredients are installed on the correct pump assemblies, the cartridge mounting structure may be different for each different viscosity range, for example, different diameter mounting ends or different attachment structures.

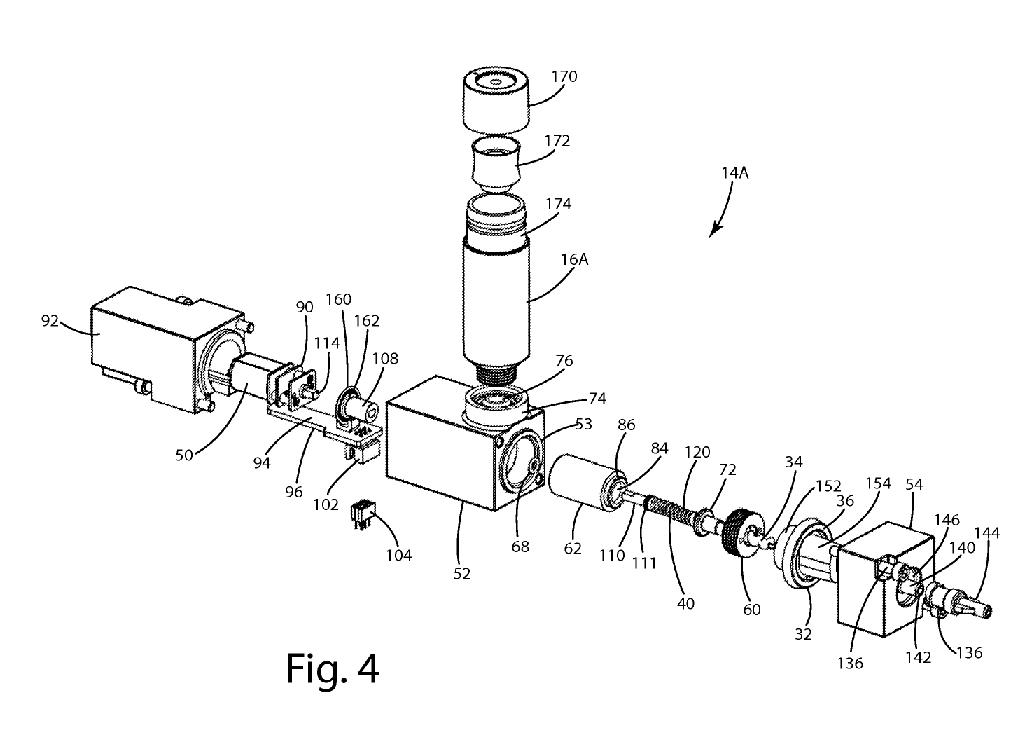

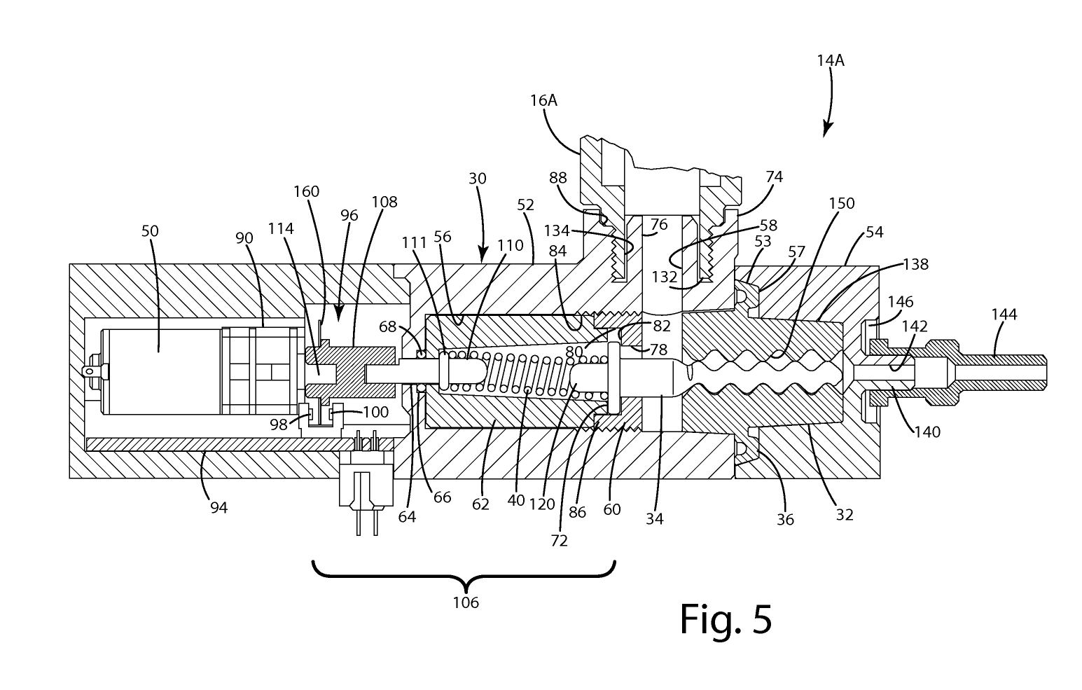

Referring now to FIGS. 4 and 5, each pump assembly 14a-d generally includes a motor 50, a pump housing 30, a stator 32, a rotor 34 and a drive coupling 106 for joining the motor 50 to the rotor 34. In operation, the motor 50 rotates the rotor 34 within the stator 32 to draw ingredients in from the cartridge 16a-d and dispense them through the dispensing head 18. In this embodiment, the pump housing 30 includes a pump body 52 and a pump head 54 that cooperatively house a stator 32 and a rotor 34. The pump body 52 of the illustrated embodiment is generally rectangular and defines an internal bore 56 and a cross bore 58. The internal bore 56 is generally cylindrical and is configured to receive a spacer sleeve 62. An input shaft opening 64 extends through the pump body 52 to allow the pump input shaft 110 to pass through the wall of the pump body 52. A counter bore 66 may be defined concentrically around the pump input shaft opening 64 to seat a seal 68. The seal 68 may engage the pump input shaft 110 to seal the motor end of the pump housing 30. In this embodiment, the rotor 34 includes an enlarged shoulder 72 that allows the rotor 34 to be secured within the internal bore 56 by a retainer 60. The retainer 60 is generally disc-shaped and defines a through bore 78 and a concentric counter bore 80. The counter bore 80 defines a running surface 82 against which the shoulder 72 of the rotor 34 rides during operation (described in more detail below). The retainer 60 may be secured in the internal bore 56 using essentially any suitable construction. In the illustrated embodiment, the retainer 60 is threaded into place within the internal bore 56. More specifically, the internal bore 56 may be internally threaded and the retainer 60 may be externally threaded so that the retainer 60 can be threaded into the pump body 52 in the appropriate location. The retainer 60 may be configured to engage the spacer sleeve 62 (described below) when properly located. The pump body 52 of the illustrated embodiment includes an annular rib 53 that protrudes from the end of the pump body 52 in concentric alignment with the internal bore 78. The rib 53 is configured to interact with a seal 36 on the stator 32, as described in more detail below. Once the pump assembly 14a-d is assembled, the seal 36 seals the interface between the pump body 52 and the pump head 54. In applications in which the stator does not include an integral seal, other sealing structures may be incorporated into the pump body 52 and the pump head 54 to provide a seal, such as annular recesses configured to receive a ring seal.

The pump assembly 14a-d may also include a spacer sleeve 62 that is fitted into the internal bore 56 and held by the retainer 60. The space sleeve 62 is generally cylindrical having an outer diameter that corresponds with the internal diameter of the internal bore 56. The spacer sleeve 62 includes an internal bore 84 that has the shape of a truncated cone. The internal bore 84 is shaped to closely correspond with the motion envelope of the flexible shaft 40. At the motor end, the internal diameter of the internal bore 84 is slightly larger than the outer diameter of the flexible shaft 40 and the shoulder of the pump input shaft 110, while at the rotor end, the internal diameter of the internal bore 84 is significantly larger to accommodate eccentric motion of the rotor 34. The space sleeve 62 may include a reduced diameter neck 86 that fits closely within the counter bore 80 in the retainer 60. When assembled, the neck 86 may be spaced from the running surface 82 of the retainer a distance sufficient to accommodate the shoulder 72 of the rotor 34. In the illustrated embodiment, the retainer 60 and spacer sleeve 62 are manufactured from a Vesconite and/or Vesconite Hilube material, which is readily available on the commercial market. This material is self-lubricating and facilitates rotational movement of the pump input shaft 110 and the stator 34. The retainer 60 and/or spacer sleeve 62 may be manufactured from other materials, as desired. For example, the retainer 60 and/or spacer sleeve 62 may be manufactured from other self-lubricating materials or materials that are not self-lubricating.

As noted above, the pump body 52 also defines a cross bore 58. The cross bore 58 is configured to provide a flow passage from the cartridge 16a-d to the pump cavity 130. In this embodiment, the pump body 52 includes a neck 74 and a throat 76 that protrudes from the pump body 52 in concentric alignment with the cross bore 58. As perhaps best shown in FIG. 5, the interior of the neck 74 is threaded to receive the threaded end of the cartridge 16a-d. In the illustrated embodiment, a seal 132 is fitted around the throat 76 at the base of the threads to seal the interface between the cartridge 16a-d and the pump housing 52. The neck 74 may include a counter bore 88 that receives the shoulder of the cartridge 16a-d. The throat 76 has an external diameter that is selected to fit closely within the cartridge opening 134. Although this embodiment includes threaded components for securing the cartridge 16a-d to the pump body 52, other attachment configurations may be used. For example, the cartridge 16a-d and the pump body 52 may be configured to utilize a bayonet-type fitting.

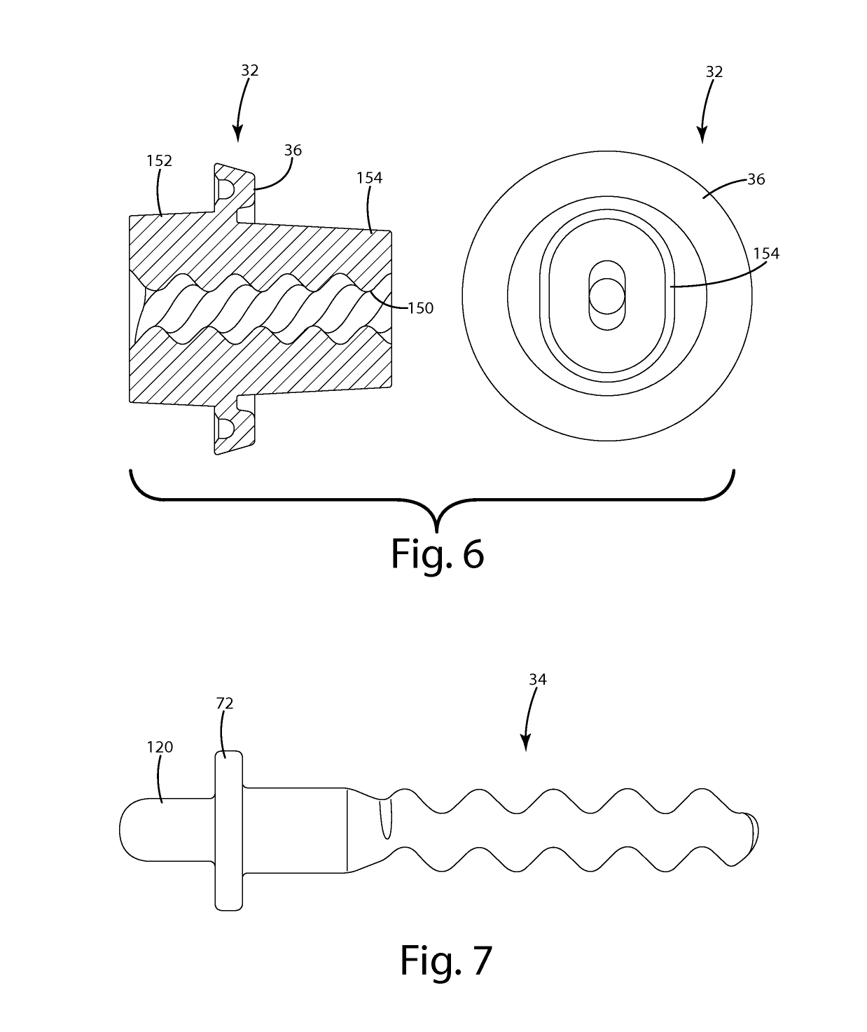

In this embodiment, the pump head 54 is generally rectangular and is configured to mount to the pump body 52. For example, as shown in FIG. 4, the pump head 54 may be secured to the pump body 52 by screws 136. The pump head 54 defines an internal bore 138 and an output stem 140. The internal bore 138 is configured to seat the stator 32. As a result, the shape of the internal bore 138 generally corresponds with the shape of the outer end of the stator 32. In this embodiment, the internal bore 138 is a truncated cone having a generally oval cross-section. The diameter of the truncated cone diminishes toward the output end of the pump head 54. This keys the stator 34 into the proper orientation within the pump head 54 and helps to prevent rotation of the stator 32 during operation. The end wall of the pump head 54 is configured to interact with the seal 36 integrated into the stator 32. More specifically, the end wall of the pump head 54 defines an annular recess 57 that is aligned with the annular rib 53. In use, the annular recess 57 and annular rib 53 sandwich the seal 55 from opposite sides. The output stem 140 is concentric with the internal bore 138 and defines a through bore 142 that allows ingredients to be dispensed from the interior of the pump assembly 14a-d. The output stem 140 may protrude from the remainder of the pump head 54 a sufficient distance to facilitate attachment of a nozzle 144. An annular recess 146 may be defined around the output stem 140 as shown in FIGS. 5 and 6.

In the illustrated embodiment, the stator 32 is manufactured separately from and fitted into the pump housing 30. The stator 32 may be manufactured from essentially any material having adequate compression and resiliency characteristics for a progressive pump. In the illustrated embodiment, the stator 32 is manufactured from nitrile rubber compound, but other examples may include silicone and polyurethane. In the illustrated embodiment, interference between the stator and the rotor is used to create a seal, thus materials for these two components should be chosen to provide adequate sealability for the working pressures of the application. As the fit of the stator and rotor is an interference fit, lubrication should also be taken into account, for example, by choosing a stator material that lubricates with the rotor material. In some applications, the material being moved by the pump may be naturally lubricating and that may be taken into account when selecting materials for the stator and the rotor. For example, oil-based materials may naturally provide adequate lubrication between the stator and rotor in many applications. The material of the stator in the illustrated embodiment is dimensionally stable and not affected by the pumped fluid. It may also be desirable to select a stator material with porosity and density characteristics such that the stator does not absorb the pumped fluid and swell or otherwise increase the interference fit, which could reduce the pumped (dosed) volume and also increase the load on the motor. The stator 32 is generally cylindrical defining an internal bore 150 with a double-helix shape. The stator 32 generally includes a motor end 152 that is configured to be fitted closely into the internal bore 56 of the pump body 52 and a dispensing end 154 that is configured to be fitted closely in the internal bore 138 of the pump head 54. Although the shape of the motor end 152 may vary, the motor end 152 of the illustrated embodiment is a truncated cone with a generally circular cross section. In the illustrated embodiment, the motor end 152 tapers at about 3 degrees. The taper may, however, vary in alternative embodiments. For example, the taper may be eliminated and the motor end 152 may be generally cylindrical. The dispensing end 154 of the stator 32 may be a truncated cone with a generally oval cross section (See FIG. 6B). In the illustrated embodiment, the dispensing end 154 tapers at about 3 degrees. The non-circular (i.e. oval) cross sectional shape of the dispensing end 154 allows the stator 32 to be keyed in place within by the closely matching non-circular shape of the internal bore 138 of the pump head 54. The shape of the dispensing end 154 may vary from application to application. For example, the taper may vary or be eliminated in alternative embodiments. As another example, the cross sectional shape of the dispensing end may vary having alternative circular or noncircular cross sectional shapes. The stator 32 of the illustrated embodiment includes an integrated flange seal 36 that locates the stator 32 (particularly in the axial direction) and seals the interface between adjacent portions of the pump housing 30. In the illustrated embodiment, the flange seal 36 is an annular protrusion disposed toward the longitudinal center of the stator 32. The seal 36 of the illustrated embodiment extends around a circumference of the stator 32 where the motor end 152 and dispensing end 154 come together. The cross sectional shape of the seal 36 is selected to match with the annular rib 53 on the pump body 52 and the annular recess 57 in the pump head 54. The flange seal 36 may be slightly larger than the cavity defined by the mating ends of the pump body 52 and the pump head 54 so that the seal 36 is compressed the desired amount when the pump body 52 and pump head 54 are properly assembled. The flange seal 36 of the illustrated embodiment is configured so that the compression forces on the flange seal 36 do not compress or otherwise materially alter the geometry of the stator 32.

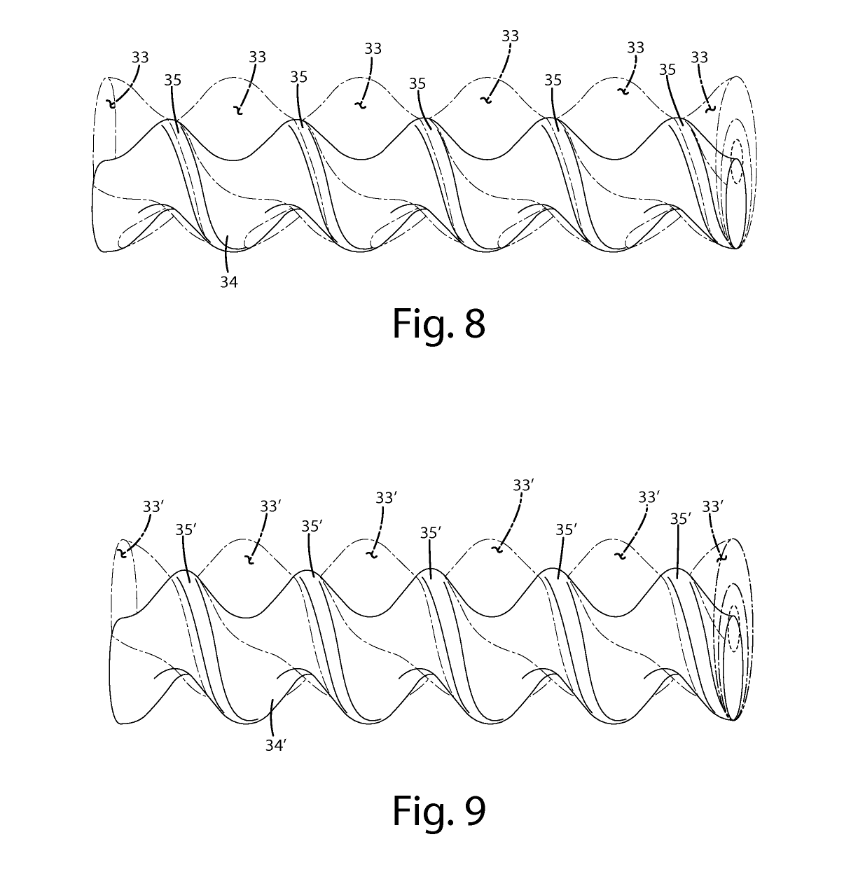

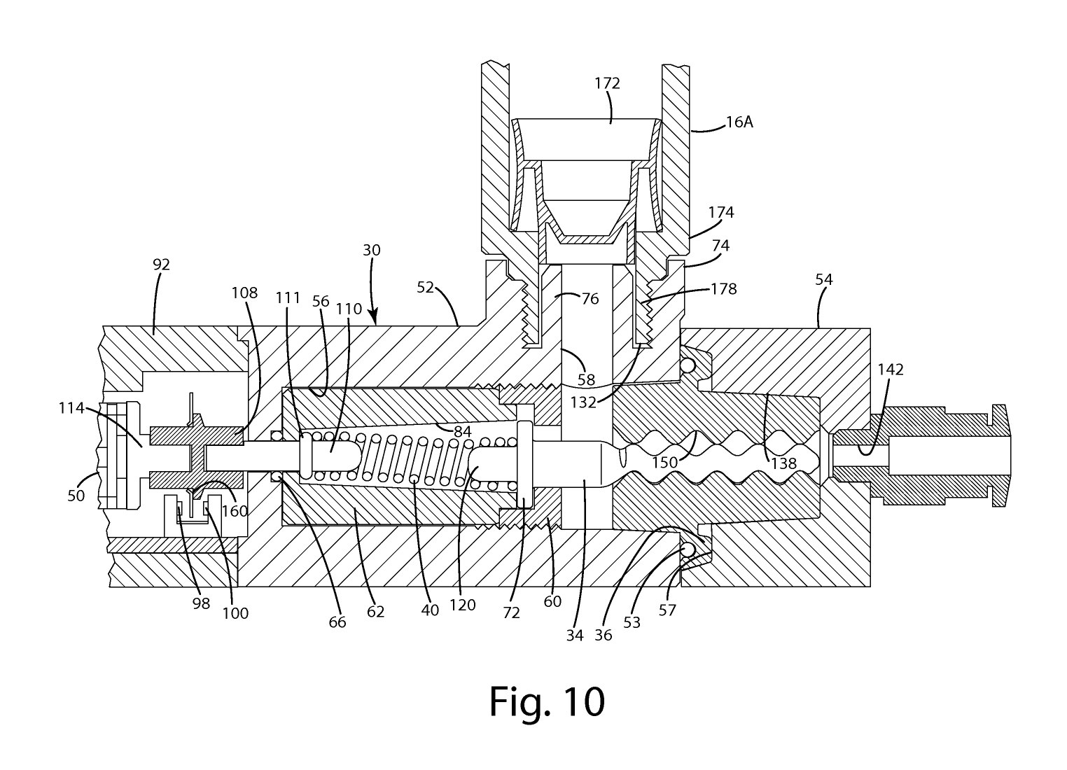

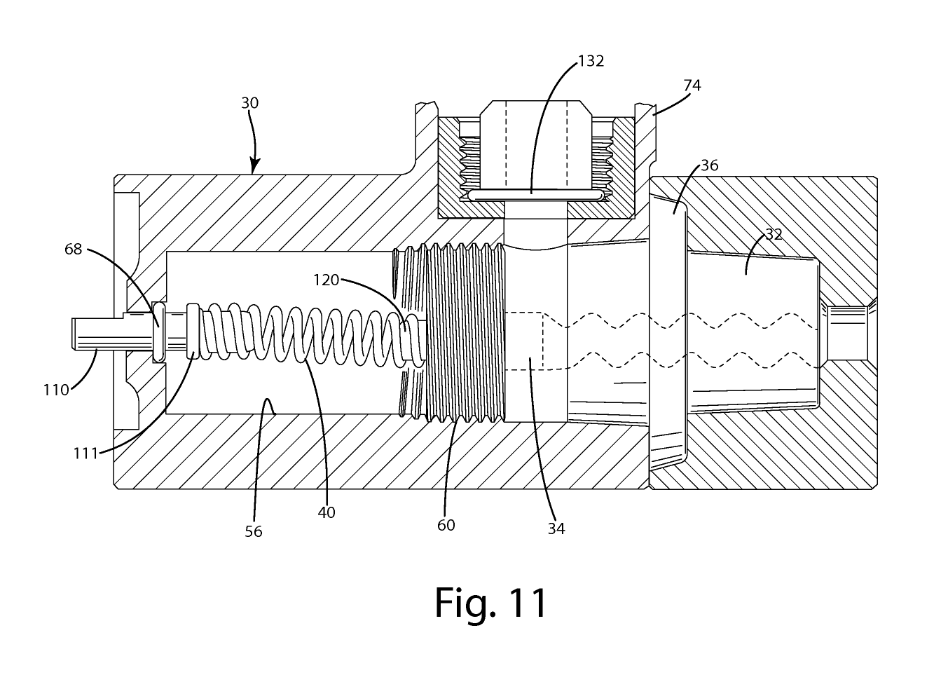

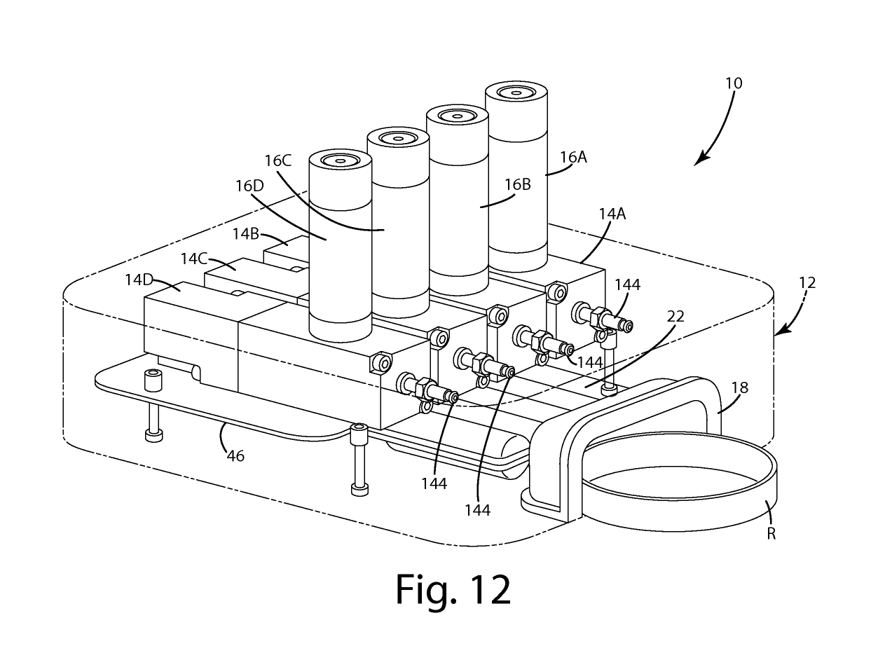

As noted above, each pump assembly 14a-d includes a rotor 34 that is rotatably fitted within the stator 32. In the illustrated embodiment, the rotor 34 has a single-helix shape that corresponds with the double-helix shape of the internal bore 150. The rotor 34 is eccentrically mounted within the stator 32. As the rotor 34 eccentrically rotates within the stator 32, the single-helix outer shape of the rotor 34 interfaces with the double-helix shaped of the internal bore 150 to define a continuous series of traveling cavities 33 that capture ingredients in the pump cavity at the inlet end and move the ingredients longitudinally along the rotor 34 through the stator 32 to the outlet end. The operation of progressive pumps and the interaction of rotors/stators for progressive pumps are well-known in the field. Accordingly, the general principles of operation will not be described in detail. Suffice it to say that the relative size and shape of the rotor 34 and stator 32 may be selected to provide the desired amount of separation between adjacent traveling cavities 33. Increased separation may provide greater control over dispensed volume and reduce the risk of communication between adjacent cavities 33. For example, FIG. 8 shows one embodiment of a rotor 34 (represented as solid) and a plurality of pump cavities (represented as translucent). The exposed regions 35 of the rotor 34 (i.e. regions not covered by a pump cavity) show the regions of interference between the external surface of the rotor 34 and the internal surface of the stator 32. In an alternative embodiment of the present invention shown in FIG. 9, the size of the rotor 34′ relative to the stator 32′ may be increased to enlarge the exposed regions 35′ (compare FIGS. 8 and 9). In effect, this reduces the size of the traveling cavities 33′ and provides increased separation between adjacent cavities 33′.

In the illustrated embodiment, the rotor 34 may include a shoulder 72 that allows the rotor 34 to be secured by a retainer 60. As shown in FIGS. 4 and 5, the shoulder 72 is generally disc-shaped and includes one planar major surface that is movably engaged with the running surface of the retainer 60 and another planar major surface that may engage with the outlet end of the spacer sleeve 62. Together, the retainer 60 and spacer sleeve 62 entrap the shoulder 72 to help retain the rotor 34 in the correct position while still allowing the rotor 34 to rotate freely. This may help to prevent the rotor 34 from moving axially or becoming askew with respect to the stator 32. In the illustrated embodiment, the rotor 34 includes an input head 120 that is configured to be coupled to the motor 50. The input head 120 of the illustrated embodiment is a generally cylindrical stem. The free end of the input head 120 is rounded in this embodiment. The design and configuration of the input head 120 may vary from application to application as desired. In the illustrated embodiment, the input head 120 is configured to be interfitted with the flexible shaft 40, which in the illustrated embodiment is a coil spring 40. As such, the diameter of the input head 120 can be larger than the internal diameter of the coil spring 40 so that there is a relatively firm interference fit. The size difference between the coil spring 40 and the input head 120 can be selected to control the amount of torque that can be transmitted from the coil spring 40 to the input head 120. The coil spring 40 of the illustrated embodiment has a right handed helix so that the coil 40 is tightened by normal operation of the motor 50. The coil spring 40 can be secured to the input head 120 by additional mechanisms, such as fasteners or adhesives. In addition to allowing eccentric motion of the rotor 34, the coil spring 40 of this embodiment provides a bias to urge the shoulder 72 into the running surface of the retainer 60. This may help to maintain a seal between the shoulder 72 and the retainer 60.

In the illustrated embodiment, each pump assembly 14a-d includes an electric motor 50, and more specifically, a generally conventional DC motor, for driving the progressive pump. The motor may vary from application to application, but in the illustrated embodiment is a small brushed geared DC motor (Part No. 951D6016V) available from RS Components. Given that the motor 50 is generally conventional, it will not be described in detail. In this embodiment, the pump assembly 14a-d includes a gear box 90 coupled to the output of the motor 50. The gear box 90 of the illustrated embodiment is mounted directly the motor 50, for example, by screws. The gear box 90 input may be mounted directly to the motor output. The gear box 90 is selected to provide the desired combination of rotational speed and torque. The gear box 90 is generally conventional and therefore will not be described in detail. Suffice it to say that the gear box 90 of the illustrated embodiment is selected to fit within the packaging constraints and to have a reduction ratio of about 1:60, but this ratio may vary from application to application as desired. In some applications, the gear box may be eliminated.

In the illustrated embodiment, the pump assembly 14a-d includes a motor housing 92 that houses the motor 50, the gear box 90, a circuit board 94 and certain components of the metering system 96. The light source 98 and the photosensor 100 may be mounted to the circuit board 94. Additionally, the circuit board 94 may support a plug 102 configured to be interfitted with a mating plug 104 from the controller 20. In this embodiment, the plugs 102, 104 provide the electrical connections that allow the controller 20 to provide electrical signals to operate the light source 98 and the motor 50, and to allow the photosensor 100 to send signals to the controller 20.

The pump assembly 14a-d includes a drive coupling 106 that operatively connects the output shaft 114 of the gearbox 90 to the rotor 34. The drive coupling 106 of the illustrated embodiment generally includes an encoding coupler 108, a pump input shaft 110 and a flexible shaft 40. The encoding coupler 108 joins the output shaft of the gear box 90 to the pump input shaft 110. As described in more detail below, the encoding coupler 108 also carries an encoding disk 112 that allows the metering system 96 to accurately meter the rotation and consequently the volume of ingredients dispensed by that pump assembly 14a-d. In the illustrated embodiment, opposite ends of the encoding coupler 108 define internal bores that are shaped to receive the gear box output shaft 114 and the pump input shaft 110. The ends of the shafts and the bores may have matching noncircular cross sectional shapes, such as “D”-shaped or square. Additionally or alternatively, the shafts may be keyed to the encoding coupler or joined by fasteners or shear pins.

The flexible shaft 40 is fitted between the pump input shaft 110 and the head 120 of the rotor 34. In the illustrated embodiment, the flexible shaft 40 is a coil spring having opposite ends fitted over the pump input shaft 110 and the rotor head 120. The flexible shaft 40 may be joined to the pump input shaft 110 and the rotor head 120 so that rotation of the pump input shaft 110 is communicated to the rotor 34. In the illustrated embodiment, the internal diameter of the coil spring is slightly smaller than the outer diameter of the pump input shaft 110 and the rotor head 120 so that the coil spring is frictionally fitted to the two shafts. In the illustrated embodiment, the coil spring 40 is installed under compression so that the coil spring 40 biases the pump input shaft 110 and the rotor 34 away from each other. This urges the shoulder 72 of the rotor 34 into contact with the retainer 60 and the shoulder 111 of the pump input shaft 110 into contact with the spacer sleeve 62. The amount of coil spring compression may be varied to control the force on the two shafts 34 and 110. The characteristics of the coil spring 40 may vary from application to application. For example, the diameter of the wire forming the spring, the diameter of the coil, the number of turns of the coil spring 40 that are engaged with the shafts 34 and 110 and the material from which the coil spring 40 is formed may vary from application to application.

As noted above, the personal formulation device 10 includes a metering system 96 for controlling the amount of ingredients dispensed by each pump assembly 14a-d. The metering system 96 may vary from application to application. In the illustrated embodiment, the metering system 96 determines volume based on rotational movement of the drive coupling, and more specifically on rotational movement of the encoding coupler 108. The metering system 96 of the illustrated embodiment includes an optical measuring system having an encoding disk 160 that is coupled to the encoding coupler 108. In the illustrated embodiment, the encoding disk 160 includes a plurality of slots 162 arranged in a radially symmetric pattern around the encoding disk 160. In one embodiment, a light source 98 (e.g. LED) and a photosensor 100 are arranged on opposite sides of the encoding disk 160 so the slots 162 in the rotating encoding disk 160 produce light pulses that pass from the light source 98 to the photosensor 100. In operation, the number of light pulse sensed by the photosensor 100 can be counted to provide an accurate measurement of the rotation of the rotor and, consequently, the volume pumped. In embodiment, the encoding disk 160 includes about 45 slots 162 so that each pulse represents about 8 degrees of rotational movement of the rotor 34. In the illustrated embodiment, the light source 98 and photosensor 100 are mounted to a circuit board 164 that is contained within the motor housing 166.

The device 10 includes a dispensing head 18, which functions to dispense the ingredients from the device 10. In this embodiment, the dispensing head 18 includes a separate outlet port (not shown) for each pump assembly 14a-d. Consequently, the ingredients are separately dispensed from the device 10 and can be manually mixed by the user. In this embodiment, the dispensing head 18 is mounted to the base 40 and is coupled to the outlets 140 of the pump assemblies 14a-b by supply lines 168a-d. The dispensing head 18 may be configured to dispense the ingredients into or onto receptacle R. In the illustrated embodiment, the receptacle R is a small dish (similar to a petri dish) that can be removed from the device 10 to facilitate use. For example, the ingredients can be dispensed into the dish R and then the dish R can be removed to facilitate mixing and application. In the illustrated embodiment, the outlet ports (not shown) are disposed in a flat surface against which the lip of the dish R can be pulled to wipe any residual ingredient from the outlet ports. Alternatively, the dispensing head 18 may have a single port for dispensing ingredients from the device. With alternative embodiments of this nature, the ingredients may be merged together prior to the outlet port. For example, the supply lines 168a-d may merge into a single supply line or into a mixing chamber prior to the outlet port. If included, the mixing chamber may include internal baffles or loose mixing components.

In this embodiment, the device 10 includes a controller 20 that is capable of operating the various pump assemblies 14a-d to dispense individual ingredients in accordance with a variety of potentially different product formulations. In general, for each formulation, the controller 20 is configured to operate the pump assembly 14a-d for each desired ingredient to dispense the amount of that ingredient required by the formulation. The controller 20 may utilize the metering system 96 to monitor and control the volume of ingredients dispensed. For example, the controller 20 may determine (or be provided with) the number of rotations of the rotor 34 required to dispense the appropriate volume of each ingredient and then use the metering system 96 associated with the corresponding pump assembly 14a-d to operate that pump assembly 14a-d until the desired number of rotations of the rotor 34 has occurred. The pump assemblies 14a-d may be operated simultaneously or sequentially, as desired. In applications where power is limited, it may be desirable to operate the pump assemblies 14a-d one at a time. In other applications, it may be desirable to operate them simultaneously to reduce overall dispensing time and to facilitate various integrated ingredient mixing options.

In one embodiment, the available formulations (or formulas) are stored in memory. For example, the controller 20 may have access to a database of formulations that can be dispensed by the device 10. The database of formulations may be contained in memory integrated into the device 10 or it may be contained in memory in a remote device that has the ability to communicate with the device 10. During use, the formulation to be dispensed may be selected from the database in various ways. For example, the formulation may be manually selected from the database by the user. As another example, selection of the formulation from the database may be automated with the device 10 (or an external device) determining the appropriate formulation from essentially any relevant information. As an example of an automated system, the device 10 may interact with an imaging system to determine the appropriate cosmetic formulation for a user based on an analysis of one or more images of the user's skin (discussed in more detail below). As an alternative to maintaining a database of formulations, the device 10 may be configured to receive formulations from a user or from a remote device during use. For example, a formulation may be manually entered by a user via a user interface (not shown) or a formulation may be determined in realtime by the controller 20 or by a remote device (not shown) that has the ability to communicate the formulation to the device 10.

When it is desirable for the controller 20 to interact with external electronic devices, the device 10 may include networking capabilities (wired or wireless). For example, the device 10 may include a wireless transceiver (not shown) that is capable of interacting with other devices over a network, such as a Bluetooth, WiFi, Zigbee or other wireless network protocols. Communications capabilities may be used to integrate the device 10 into a larger network of devices that assist a user in tracking activities and making recommendations that help the user maintain/improve health and well-being. If provided with communications capabilities, the device 10 may be configured, among other things, to obtain formulations from a remote device, to obtain data that allows the device 10 to determine the appropriate formulation via the network, to provide dispensing information to a remote device(s) capable of tracking historical data relating to formulation use and facilitate automatic reordering of ingredients when supplies run low. The device 10 may also be provided with a user interface (not shown) that allows a user to input efficacy information that can be relayed to the network of devices and used to help the network make improved formulation decisions. As an alternative to integrating a user interface into the device 10, the controller 20 may be configured to wirelessly interact with an application being run on a remote device (such as a smart phone or tablet). For example, an application run on a smart phone may be used to display available options to the user and to allow the user to select or enter a desired formulation.

In this embodiment, the device 10 is capable of being powered by rechargeable batteries, and therefore includes a battery pack 22. Alternatively, the device 10 may include other rechargeable electrical energy storages devices, such as one or more high capacity capacitor(s) (e.g. supercapacitors or ultracapacitors). The device 10 may include a wireless charging system (not shown) capable of wirelessly receiving power for charging the battery pack 22 from an external wireless power supply (not shown). Alternatively, the device 10 may be charged via a wired connection. For example, as shown in FIG. 1, the device 10 may include a power input port 23 and an on/off switch 25 that are accessible from the back side of the housing 12. The device 10 may include alternative sources of power, such as non-rechargeable batteries, a direct wireless power supply or a wired power supply.

As noted above, the personal formulation device 10 is configured to receive replaceable cartridges that contain the desired ingredients. The design and configuration of the cartridges may vary from application to application. In this illustrated embodiment, the personal formulation device 10 is configured to receive interchangeable cartridges 16a-d that can be selectively screwed into the pump housing 52. In this embodiment, the cartridges 16a-d are generally identical. Accordingly, only a single cartridge 16a will be described in detail. Referring now to FIG. 4, the cartridge 16a generally includes a container body 174, a cap 170 and a plunger 172. The container body 174 defines an interior space 176 designed to receive the ingredients. One end of the container body 174 includes a neck 178 that is configured to engage the pump housing 52. In this embodiment, the neck 178 is externally threaded with threads that mate with corresponding threads in the pump housing 52. The neck 178 may include a shoulder 180 configured to be closely received in counter bore 88 in the pump housing 52. An internally-threaded removable cap (not shown) may be used to close off the end of the cartridge 16a-d when it is not installed on the pump housing 52. The other end of the container body 174 is open. This allows the plunger 172 to be fitted into the interior space 176. The plunger 172 is configured to engage and form a seal against the interior of the container body 174. The cap 170 is fitted over the open end of the container body 174 to close the container body 174 and secure the plunger 172 in the interior space 176. The cap 170 may be snap-fitted onto the container body 174 and/or it may be secured using other mechanisms, such as adhesives or plastic welding. The cartridges 16a-d may be replaced with essentially any form of container or other type of reservoir capable of storing a supply of an ingredient.

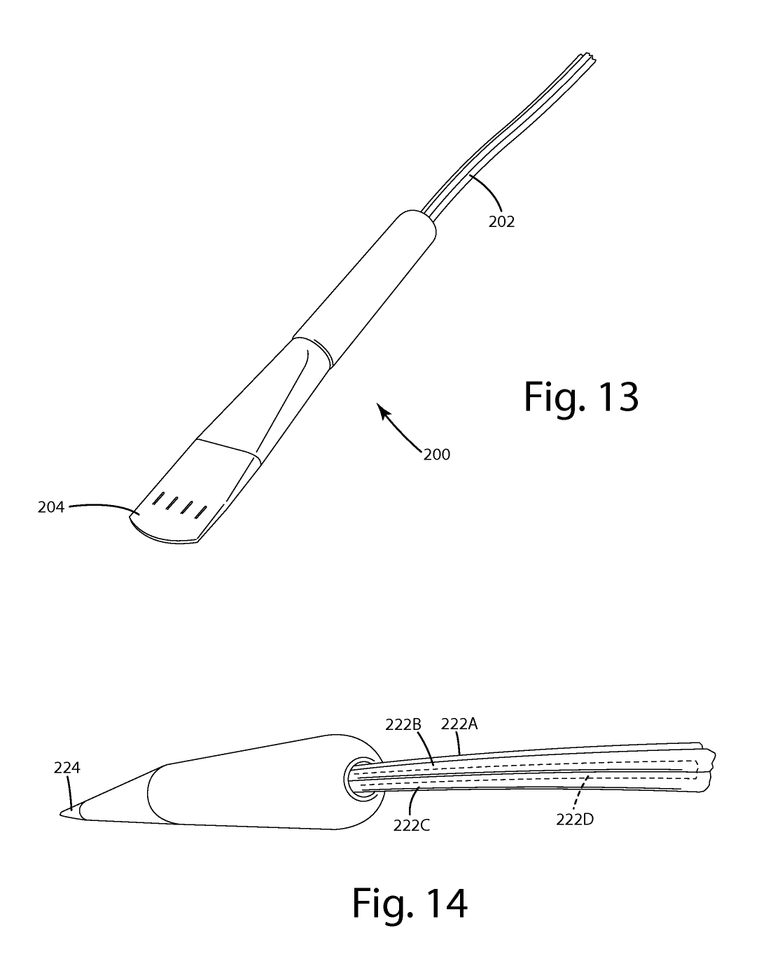

In the illustrated embodiment, the personal formulation device 10 includes a fixed dispensing head 18 that is integrated into the housing. Alternatively, the personal formulation device may include other types of dispensers, such as a stylus for dispensing ingredients from the device. The stylus may vary in design and configuration. In some embodiments, the various ingredients are separately dispensed form the stylus, and the end of the stylus is used to mix the ingredients after they have been dispensed. In other embodiments, the stylus may include integrated mixing features that help to mix or partially mix the ingredients before they are dispensed. The stylus may include a variety of alternative mixing features. As examples, various alternative styluses are shown in FIGS. 13, 14, 18A, 18B, 19 and 20. FIG. 13 shows a first stylus 200 having a single feed line 202 and a paddle-like tip 204. In this embodiment, the supply lines 168a-d merge together upstream from the stylus 200 so that a single feed line 202 communicates the ingredients to the stylus 200. The stylus 200 includes an outlet (not shown) that allows the ingredients to be discharged from the stylus 200. After the ingredients have been dispensed, the tip 204 of the stylus 200 can be used to perform any additional mixing desired and then used to apply the formulation. FIG. 14 shoes an alternative stylus 220 that is essentially identical to stylus 200, except that it includes four feed lines 222a-d. This allows the different ingredients to be separately conveyed to the stylus tip 224 for dispensing. In this embodiment, the four feed lines 222a-d may merge together within a void or cavity (not shown) inside the stylus 220 before exiting through a single outlet (not shown). Alternatively, all four feed lines 222a-d may have separate outlets (not shown) in the stylus 220.

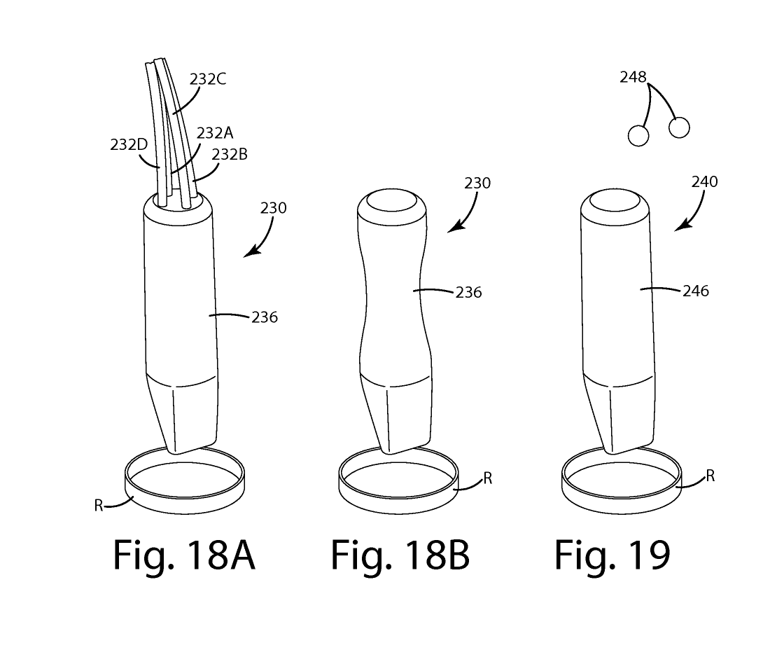

FIGS. 18A-B, 19 and 20 are alternative stylus configurations that have integrated mixing features. FIGS. 18A-B shows a stylus 230 configured to provide mixing through a flexible stylus body 236 that can be squeezed to mix the various ingredients. In FIGS. 18A-B, the stylus 230 receives ingredients from a personal formulation device having four ingredient output lines 232a-d. In this embodiment, the stylus 230 includes a generally hollow body 236 into which the feed lines 222a-d empty. The hollow body 236 is manufactured from a flexible material, such as a flexible plastic. In use, the hollow body 236 can be kneaded by the user to mix and dispense the ingredients. In another alternative embodiment shown in FIG. 19, the stylus 240 includes internal mixing balls 248 that are contained within a cavity (not shown) inside the stylus 240. In use, the ingredients are dispensed into the cavity and the stylus 240 can be shaken so that the mixing balls 248 move through the ingredients to mix them. The mixed ingredients may be dispensed from the stylus 240 in various ways. For example, the stylus 240 may have a flexible body 246 and the mixed ingredients may be dispensed by squeezing the stylus body 246. As another example, the ingredients may be dispensed by operating the device 10 to introduce further material that pushes out the mixed ingredients.

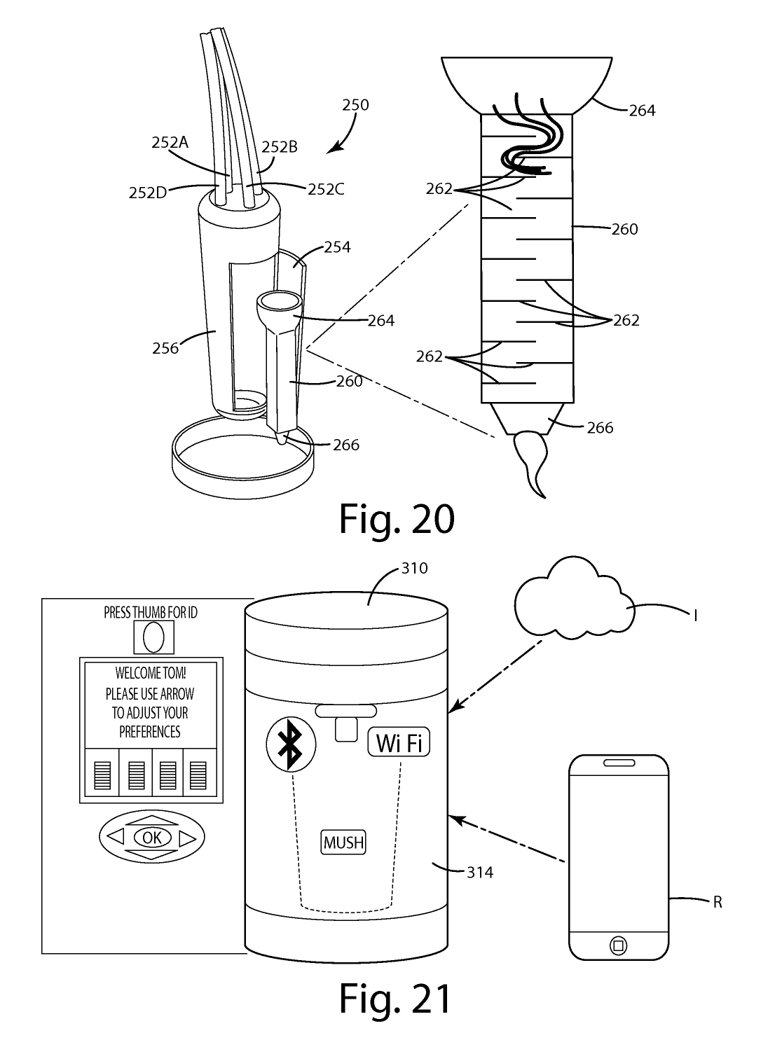

FIG. 20 shows another embodiment in which the stylus 250 includes a static mixing tip 260 that is fitted into the stylus body 256 to provide a structure intended to help mix the various ingredients. The static mixing tip 260 may be a disposable component that is removed and replaced as desired, such as after each use or each time that the ingredient output varies. The static mixing tip 260 may include a skirt 264 that is fitted over the output ends of the ingredient output lines 252a-d to funnel the ingredients into the baffled flow path. The static mixing tip 260 may also include an output nozzle 266 that is fitted through an aperture 270 defined in the bottom of the stylus 250. The stylus 250 of FIG. 20 includes a stylus body 256 with a door 254 that can be opened and closed to provide access to an internal void configured to receive the mixing tip 260. In alternative embodiments, the door 254 may be eliminated. In the illustrated embodiment, the static mixing tip 260 includes a plurality of internal baffles 262 that help to mix the various ingredients. The baffles 262 may be essentially any structure capable of causing the various ingredients to mix. For example, the baffles may be walls (as shown), prongs, spirals or other structures that interfere with the ingredient flow path inside the static mixing tip. In the illustrated embodiment, the static mixing tip 260 is slightly longer than the stylus body 256 so that it is held tightly in place by an interference fit. The static mixing tip 260 may be secured to the stylus 250 in alternative ways. For example, in alternative embodiments, the mixing tip 260 may be removably fitted to the end of the stylus, for example, by a snap-fit or by threads.

Operation.

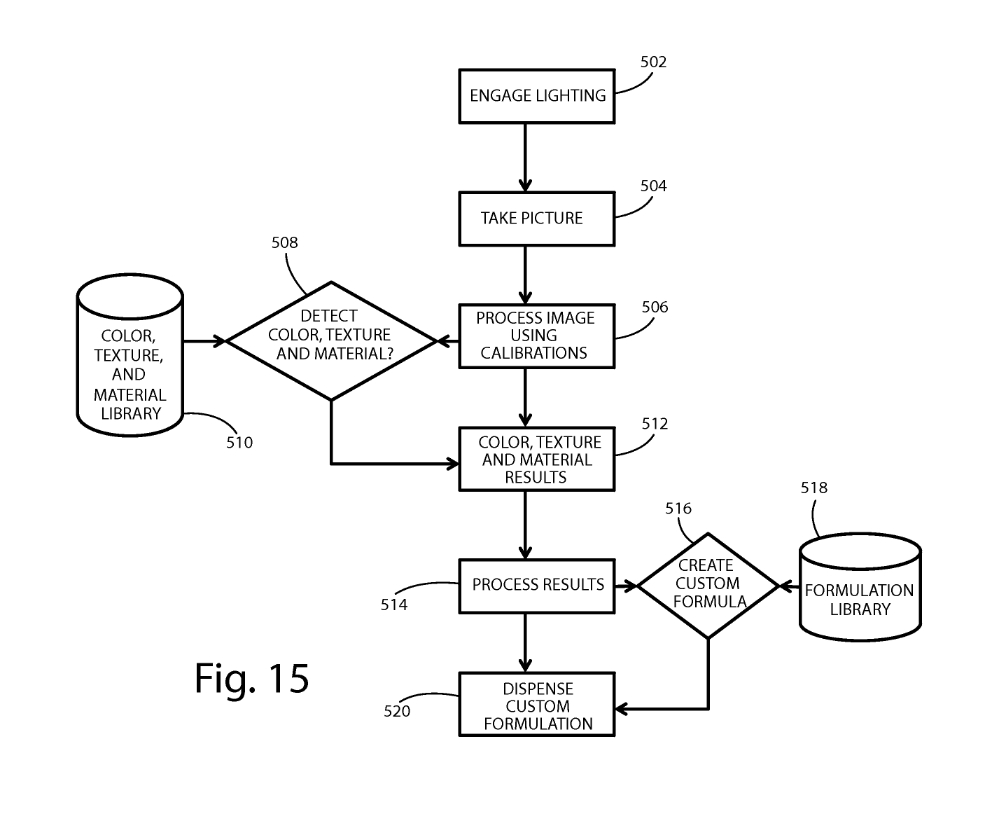

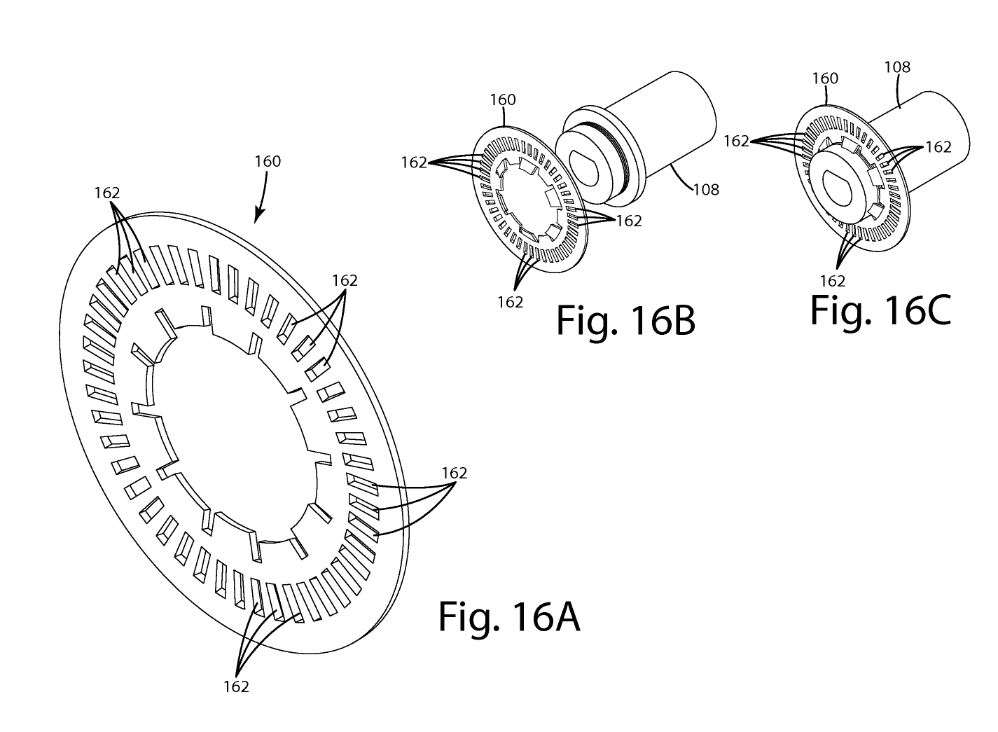

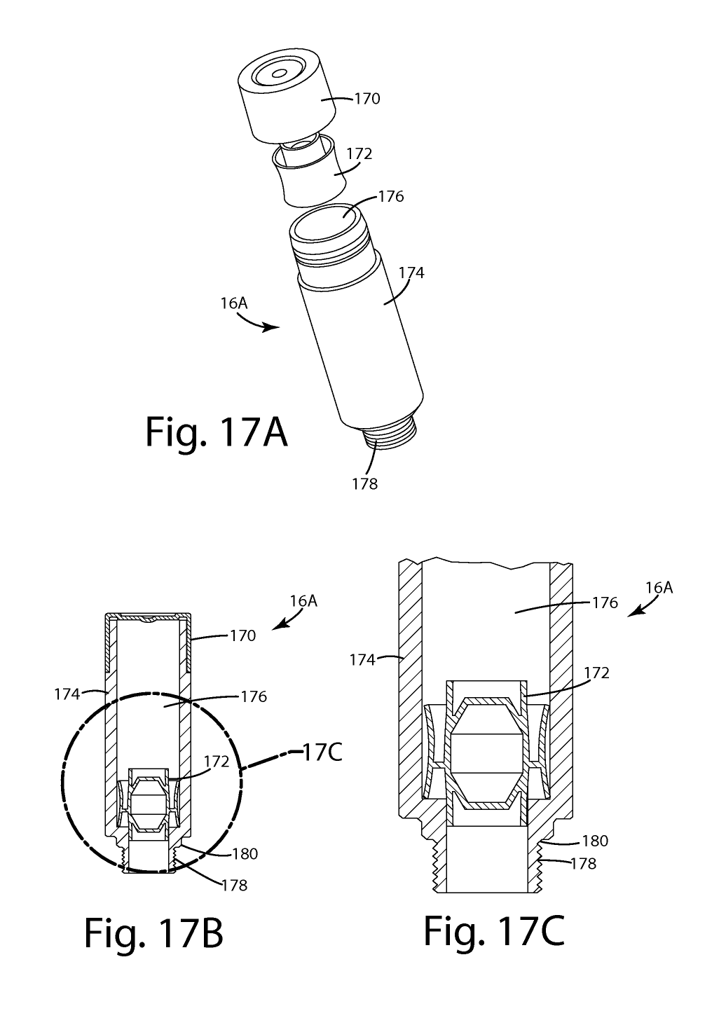

A process of generating and dispensing a custom cosmetic formulation will now be described in connection with the flow chart of FIG. 15. In this application, the formulation is developed based on one or more images of the user. For example, if the cosmetic formulation is intended for use on a user's face, one or more images of the face can be taken and analyzed using a computer to produce a customer cosmetic formulation. In the illustrated embodiment, the process of generating a formulation is performed by an imaging system (not shown) that includes a digital camera and a computer for processing the images obtain by the digital camera. In general, the process includes the steps of taking an image with the digital camera, providing the image to the computer, calibrating the image using the computer, assessing color texture and material using the computer, obtaining the appropriate formulation from a formulation library using the computer based on color, texture and material as an index. Once determined, the formulation is communicated to the device 10, and the device 10 can prepare and dispense the cosmetic formulation. The process 500 of determining an appropriate formulation may be performed before any use of the device 10 and may be repeated, as desired. For example, it may be desirable to perform the process 500 once for each type of cosmetic capable of being produced by the device 10, such as a moisturizer, a foundation, color cosmetics, lip stick, rouge, eyeliner or other cosmetics. In cosmetics applications, the ingredients may be essentially any ingredients that might be included in cosmetics and be capable of being dispensed using the pump assemblies 14a-d of the present invention. For example, the ingredients may include base cosmetics, color additives and skin care additive, such as moisturizers, UV block, anti-aging additives and anti-wrinkle additives.

The process 500 begins at block 502 where the subject is prepared for image capture by engaging the desired lighting. The lighting may vary from application to application as desired. For example, the subject may be positioned in an image capture booth and lighting within the booth may be engaged. The type, number, position and brightness of the lighting may vary as desired to provide images that are optimized for processing. In some applications, lighting may be unnecessary or may not be desired. In such applications, this step may be eliminated.

Once any desired lighting has been engaged, the desired image (or images) may be taken at block 504. The system may rely on a single image or utilize a plurality of images. The plurality of images may, for example, be taken using different cameras or different lenses, of different regions, at different angles or use different lighting.

After the image(s) have been taken, control passes to block 506. At block 506, the images may be processed as desired to facilitate analysis. For example, the images may be processed using one or more calibration algorithms. These algorithms may remove variation from the images so that images taken at different times can be processed in a consistent and repeatable manner. Various types of image calibration and associated algorithms are known and therefore will not be described in detail. Suffice it to say that the embodiments of the present invention may utilize essentially any form (or forms) of image calibration.

The processed images may then be analyzed at block 508 to assess select characteristics of the subject. For example, the controller may use conventional detection algorithms to detect color, texture and material in the images. These and other types of image detection algorithms are well-known and therefore will not be described in detail. Suffice it to say that the detection algorithms may perform an analysis of the images and compare the results of that analysis with a library (block 510) of known characteristics. For example, the detection algorithms may utilize color, texture and material libraries to determine the color, texture and material shown in the images (See block 512).

The system may process the results of the color, texture and material detection process at block 514 to yield a composite result that is used to create the custom formulation. At block 516, the device 10 may use the results of the processing performed at block 514 as a key to look-up the appropriate product formulation from a formulation library (See block 518). The device 10 may store the custom product formulation in memory so that it can be used to dispense the custom formulation again in the future.

Upon determining the appropriate formulation, the device 10 may dispense the custom formulation (See block 520). For example, the device 10 may operate the appropriate pump assemblies 14a-d for the amount of time required to dispense the ingredients in the volumes specified in the product formulation.

As noted above, the present invention can be used in a wide range of applications that involve the dispensing of various liquids, powders and other materials that have liquid-like flow properties. Pumps manufactured in accordance with this disclosure can be provided with the ability to accurately dispense these materials to a microliter level. Systems incorporating the pumps disclosed herein can include control systems that allow time released dispensing. The control systems can also be provided with the ability to communicate with external devices, which allows the systems to be controlled by a remote device, such as a smart phone running a control application. For example, a personal formulation device integrated into a water/beverage dispenser 310 is shown in FIG. 21. In this embodiment, the device 310 includes Bluetooth (e.g. BTLE) and WiFi capability so that the dispenser 310 can connect to the internet I and communicate with other internet-connected devices, or can connect directly with remote devices, such as smart phone R. As a result of these characteristics, the present invention is suitable for use in a large number of different applications.

One potential application for the present invention is the dispensing of medication. For example, devices manufactured in accordance with the present invention can be used to dispense any liquid or powder form of pharmaceutical medication down to microliter resolution. This opens up a wide variety of medication options because the devices have such a fine resolution. The dispensed material could be dispensed into water or mixed with food for ingestion. This could be beneficial to anyone with difficulties swallowing pills or tablets. Being that the formulation device can be provided with BTLE and WIFI, the device can be used to monitor dispensing habits and remind a user of a missed dose. This could help with medication and supplement compliance. This could also help eliminate over medicating a patient that might have been prescribed a potentially harmful medication. Also, the prescribing doctor or pharmacist could change dosing levels on the fly based on the needs of the patient. Being that the device can be controlled via BTLE or WIFI, it could be used for user-specific supplement regiment. This may allow a single device to be used by multiple users, and also prevent use of medication not prescribed to a specific user (e.g. pain medications). The formulation device could also be used as a deterrent from prescription medication abuse by only allowing it to dispense after a given amount of time.

Another potential application for personal formulation devices in accordance with the present invention is supplementation (e.g. nutritional supplements) and flavor addition to water and other beverages. For example, in the context of a water treatment system, micro pumps in accordance with the present invention can be integrated into a water treatment system 314 (See FIG. 21), added to an already existing water treatment system (not shown) or as a standalone device to add different types of supplementation to water and other beverages. Although described in the context of a water treatment system, the present invention may similarly incorporated for use with other beverage dispensers, such as coffee makers or tea brewers. The additives could include vitamins, protein, carbs, electrolytes, etc. to help the body recover after workouts or being sick. Different flavors can additionally or alternatively added and because the amount is so exact this can be completely customizable. Other things that can be combined with water or other beverages could be probiotics to help with indigestion, antacids and heartburn medication that can be distributed around meals that are known to be spicy. Because the device can be connected to the internet and to remote devices that are running control applications, the opportunity for smart supplementation is a possibility. For example, certain supplements, such as creatine, require loading phases where more is taken at multiple times in a day, followed by a maintenance stage where only small amounts are taken once a day, and then a cycling on and off period is necessary. The appropriate consumption regime can become difficult to remember so it may be helpful if this device can automatically add this to your drinking water every time you approach it. The control system can be programmed to understand your required regimen and at what point in time you are so that it can provide appropriate dispensing. This could also be applied to something like acne medication that starts out intense and slowly backs off over time. Another example is allergy medication that can be given when there is a pollen count above a certain level. This number (e.g. pollen count) can automatically be sent to the device by an internet-connected device or by a directly connected remote device, and a decision about whether the medication should be distributed and, if so, how much should be distributed can be made by the personal formulation device. Alternatively, the decision about whether and how much to distribute may be made remotely and only the dispensing instructions may be provided to the personal formulation device.

Air treatment is another application for micro pumps in accordance with the present invention. Very small amounts of liquid scents, can be dispensed and vaporized periodically to freshen the air of the room. This can be “smart” and happen when people enter or leave a room, etc. For example, the air treatment system or a personal formulation device joined to an air treatment system may include a motion sensor that can dispense a scent when motion within the room is detected. Another thing that can be incorporated into an air treatment system is liquid vitamins such as vitamin C, or vitamin E. Vitamin can be absorbed into the skin and this could increase during cold season to make sure the immune system is guarded against disease. Vitamin E could help keep the skin moist and hydrated during dry winter months. As with scents, vitamins can be dispensed when triggered by motion in the presence of the air treatment system.

Another application for personal formulation devices in accordance with the present invention is homecare. In this context, the pumps can store concentrated amounts of all sorts of shampoo, laundry detergent, dish detergent, hand soap, etc. Because of the concentrated liquid, it can be stored in a small compact size providing nice space savings. This can be beneficial because exact amounts of cleaner can be added to any cleaning situation and optimize the amount you need. This could provide a cost savings and also an environment impact limiting the amount of wasted cleaner. This can also be a smart timed application and different cleaners added at different points in time.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A device for dispensing ingredients in accordance with a formulation comprising:
a plurality of ingredient reservoirs, each of said reservoirs containing a supply of an ingredient;
a dispenser through which ingredients are dispensed from the device;
a plurality of pump assemblies, each of said pump assemblies having an inlet operatively coupled to a corresponding one of said plurality of pump assemblies, each of said pump assemblies having an outlet operatively coupled to said dispenser, each of said pump assemblies including a progressive pump with pump housing containing a stator and a rotor, said stator being manufactured from a resilient material and having an integrated external seal, said pump housing having a first portion and a second portion, said seal compressed between said first portion and said second portion to seal the pump housing and locate said stator with respect to said first portion and said second portion; and
a controller for individually operating said plurality of pump assemblies to dispense said ingredients from said dispenser in accordance with the formulation.

2. The device of claim 1 wherein said stator includes a key portion having a noncircular cross section and said pump housing includes a key portion having a noncircular cross section corresponding with said key portion of said stator, said key portion of said stator being disposed in said key portion of said pump housing.

3. The device of claim 1 wherein each of said pump assemblies includes a motor, each of said motors being coupled to a corresponding one of said rotors by a flexible coupling.

4. The device of claim 3 wherein said flexible coupling includes a coil spring.

5. The device of claim 4 further comprising a metering system incorporated into each of said pump assemblies.

6. The device of claim 5 wherein said metering system includes an optical metering system having an encoding coupler that is incorporated into a drive coupling between said motor and said rotor, whereby said encoding coupler rotates with said motor and said rotor.

7. The device of claim 6 wherein said encoding coupler includes an encoding disk with a plurality of apertures, said metering system including a light source disposed on one side of said encoding disk and a photosensor disposed on an opposite side of said encoding disk.

8. The device of claim 3 wherein said flexible coupling is disposed within said first portion of said pump housing; and
wherein each of said pump assemblies includes a spacer fitted within said first portion of said pump housing, said spacer defining an internal bore configured to closely correspond with a motion envelope of said flexible coupling.

9. The device of claim 8 wherein said bore of said spacer has an input end and an output end said bore becoming increasingly larger from said input end to said output end.

10. The device of claim 1 wherein said seal extend circumferentially about said stator.

11. The device of claim 10 wherein at least one of said first portion and said second portion of said pump housing includes an annular rib corresponding with said seal, the other of said first portion and said second portion of said pump housing including an annular recess corresponding with said seal, said seal being compressed between said annular rib and said annular recess.

12. The device of claim 1 wherein each rotor includes a circumferential shoulder; and
further including a retainer fixed within said pump housing, said retainer entrapping said shoulder of said rotor.

13. The device of claim 12 wherein each of said pump assemblies includes a spacer fitted within said first portion of said pump housing, said shoulder of said rotor disposed between said spacer and said retainer.

14. The device of claim 12 wherein said retainer is externally threaded and said pump housing is internally threaded, whereby said retainer is threadedly installed in said pump housing.

15. The device of claim 1 further including a device housing containing said pump assemblies; and
wherein said dispenser includes a dispensing head incorporated into said housing, said dispensing head defining a separate outlet for each of said plurality of pump assemblies.

16. The device of claim 1 wherein said dispenser includes a stylus coupled to said plurality of pump assemblies by a plurality of feed lines.

17. The device of claim 16 wherein said stylus has a flexible body, whereby said body can be manually squeezed to mix or dispense ingredients from said stylus body.

18. The device of claim 16 wherein said stylus defines an internal cavity and includes at least one mixing element loosely contained within said internal cavity, whereby said stylus can be shaken to mix ingredients within said internal cavity.

19. The device of claim 16 wherein said stylus include a replaceable tip, said replaceable tip being removably secured to said stylus.

20. The device of claim 19 wherein said replaceable tip defines an internal flow path through which ingredients flow through said replaceable tip, said replaceable tip including a plurality of baffles within said flow path.

21. The device of claim 1 further including a wireless transceiver, wherein said controller is capable of communicating with a remote device via said wireless transceiver.

22.-38. (canceled)

39. A portable device for dispensing ingredients in accordance with various formulations comprising:
a plurality of pump assemblies, each of said pump assemblies having an inlet and an outlet, each of said pump assemblies including a motor operatively coupled to a progressive pump by a drive coupling, said progressive pump configured to draw ingredients into said progressive pump through said inlet and discharge ingredients through said outlet;
each of said progressive pumps including a pump housing having a first portion and a second portion that cooperatively house a stator and a rotor;
said stator defining a double-helical bore and having an integrated external seal compressed between said first portion and said second portion of said pump housing;
said rotor having a helical shaft and mounted for eccentric movement within said double-helical bore of said stator;
said drive coupling including an input shaft and a flexible coupling for joining said input shaft and said rotor, said flexible coupling translating rotation of said input shaft into eccentric rotation of said rotor;
a plurality of ingredient cartridges, each of said cartridges containing a supply of one of the ingredients and being uniquely coupled to said inlet of one of said plurality of pump assemblies;
a dispenser through which ingredients are dispensed from the device, said dispenser coupled to said outlet of each of said plurality of pump assemblies; and
a controller for individually operating said plurality of pump assemblies to dispense said ingredients from said dispenser in accordance with the formulation.

40. The device of claim 39 wherein said flexible coupling includes a coil spring.

41. The device of claim 40 further comprising a metering system incorporated into each of said pump assemblies, each of said metering system including an optical metering system having an encoding coupler that is incorporated into said drive coupling between said motor and said flexible coupling, whereby said encoding coupler rotates with said motor and said rotor.

42. The device of claim 41 wherein said encoding coupler includes an encoding disk with a plurality of apertures, said metering system including a light source disposed on one side of said encoding disk and a photosensor disposed on an opposite side of said encoding disk.

43. The device of claim 39 wherein each of said pump assemblies includes a spacer fitted within said first portion of said pump housing, said spacer defining an internal bore configured to closely correspond with a motion envelope of said flexible coupling.

44. The device of claim 39 wherein said seal extends circumferentially about a central portion of said stator.

45. The device of claim 44 wherein at least one of said first portion and said second portion of said pump housing includes an annular rib corresponding with said seal, the other of said first portion and said second portion of said pump housing including an annular recess corresponding with said seal, said seal being compressed between said annular rib and said annular recess.

46. The device of claim 1 wherein each rotor includes a circumferential shoulder; and
further including a retainer fixed within said pump housing to entrap said shoulder of said rotor.

47. The device of claim 46 wherein each of said pump assemblies includes a spacer fitted within said first portion of said pump housing, said shoulder of said rotor disposed between said spacer and said retainer.

48. The device of claim 39 further including a wireless transceiver, wherein said controller is capable of receiving the formulation from a remote device via said wireless transceiver.
